(19) United States
(12) Patent Application Publication
(10) Pub. No.: US 2025/0247248 A1
(43) Pub. Date: Jul. 31, 2025

(54) DEVICE AND METHOD FOR OWNING AND TRADING VERIFIABLE PERSONAL DATA THROUGH BLOCKCHAIN BASED PERSONAL WEB NODES

(71) Applicant: BLOCKCHAIN LABS INC., Seoul (KR)

(72) Inventors: Yong Tae KIM, Seoul (KR); Byung Wan LIM, Seoul (KR)

(73) Assignee: BLOCKCHAIN LABS INC., Seoul (KR)

(21) Appl. No.: 19/038,309

(22) Filed: Jan. 27, 2025

(30) Foreign Application Priority Data
Jan. 26, 2024 (KR) 10-2024-0012155

(51) Int. Cl. H04L 9/32; H04L 9/08

(52) U.S. Cl. CPC H04L 9/3247; H04L 9/0819; H04L 9/3263

(57) ABSTRACT

A personal web node corresponding to a first identifier is disclosed. The personal web node comprises a storage for storing data and at least one processor. The at least one processor is configured to: transmit a data download request to a service provider corresponding to a second identifier, receive a data package including personal data and a data certificate from the service provider, wherein the data certificate includes the first identifier as information about an owner of the personal data, and a second electronic signature based on a second identifier for verifying a source of the personal data, verify the second electronic signature based on the second identifier and a blockchain network, extract the personal data from the data package, and store the personal data and the data certificate for the personal data into the storage. In addition to the above, various embodiments identified through the specification are possible.

### CROSS-REFERENCE TO RELATED APPLICATION

This application claims priority to Korean Patent Application No. 10-2024-0012155 filed on Jan. 26, 2024, and all the benefits accruing therefrom under 35 U.S.C. § 119, the contents of which are incorporated by reference in their entirety.

### BACKGROUND

The embodiments disclosed in the present disclosure relate to WEB 3.0 technology.

### SUMMARY

Individuals create various data while using various services on web. The created data is stored and managed in databases operated by each service provider. Although individuals are the creators of the data, but they do not possess control over the data they created.

Furthermore, with the widespread use of personal data in the development of artificial intelligence, such as large language models (LLMs) and search engines, issues concerning the infringement of ownership or copyright of the data creators have emerged. A potential solution to this issue is to compensate the individuals who generate the data appropriately. However, there is currently no technical method to verify data ownership and facilitate payment.

Accordingly, there is a need for a standard protocol and technical method that allows the individual who created the data to store and manage the data that is fragmented and stored across numerous service providers, and further allows the individual who created the data to distribute and trade the data.

For individuals to own and distribute their data, metadata of the data, such as whether the data has been falsified, source, and a date of creation, must be trustworthy. For example, when an individual downloads SNS service usage records from an SNS service provider and wants to own and sell them, the buyer must verify the source of the SNS service provider and confirm that the data is the original data downloaded from the service provider without falsification or modification. The various embodiments disclosed in the present disclosure are intended to generate and distribute personal data in a form in which anyone can verify the ownership and source of the data through blockchain networks, DID (Decentralized Identifier), and VC (Verifiable Credentials) web standard technologies.

In addition, since data is generated in the process when individuals use various services, the data is stored on the web in various ways defined by each service provider. Therefore, even if data is collected in a storage where individuals can directly own it, it is necessary to standardize the data in different formats in order to distribute it and further sell it to a third party. The various embodiments disclosed in the present disclosure are intended to structure data stored from different service providers to be mutually compatible by storing the data in a standardized form, and to facilitate distribution and transactions.

Furthermore, the various embodiments disclosed in the present disclosure are intended to utilize smart contract technology of a blockchain network to enable profits generated during data transactions to be transparently distributed to individuals and service providers.

According to the embodiments disclosed in the present disclosure, a personal web node corresponding to a first identifier, the personal web node comprising a storage for storing data and at least one processor, wherein the at least one processor is configured to: transmit a data download request to a service provider corresponding to a second identifier, receive a data package including personal data and a data certificate from the service provider, wherein the data certificate includes the first identifier as information about an owner of the personal data, and a second electronic signature based on a second identifier for verifying a source of the personal data, verify the second electronic signature based on the second identifier and a blockchain network, extract the personal data from the data package, and store the personal data and the data certificate for the personal data into the storage.

According to the embodiments disclosed in the present disclosure, a new protocol may be provided that allows anyone to own and distribute their own data in a verifiable form. This protocol enables proof and monetization of personal data. In addition, various effects may be provided that are directly or indirectly identified through the present disclosure.

### BRIEF DESCRIPTION OF THE DRAWINGS

FIG. 1 is a diagram for explaining the configuration and operation of a personal web node according to an embodiment.

FIG. 2 is a diagram for explaining a personal web node protocol according to an embodiment.

FIG. 3 is a block diagram of a personal web node according to an embodiment.

FIG. 4 is a signal flow diagram showing a process in which a personal web node downloads personal data and generates index information for the personal data according to an embodiment.

FIG. 5 is a signal flow diagram showing a data transaction process between personal web nodes according to an embodiment.

With respect to the description of the drawings, the same or similar reference signs may be used for the same or similar elements.

### DETAILED DESCRIPTION OF EMBODIMENTS

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure.

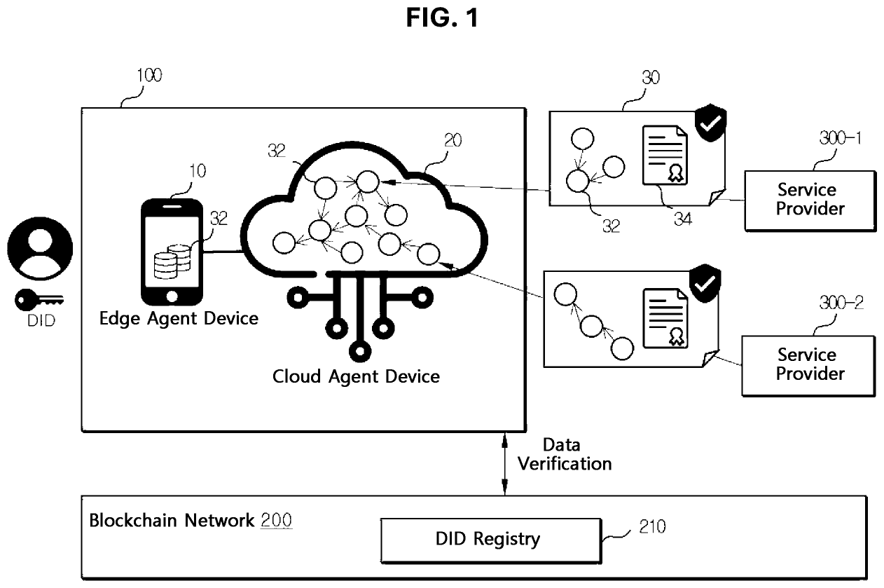

FIG. 1 is a diagram for explaining the configuration and operation of a personal web node 100 according to an embodiment. The personal web node 100 according to an embodiment may include an edge agent device 10 and a cloud agent device 20 that operates in conjunction with the edge agent device 10 through a network. The personal web node 100 may be controlled by the edge agent device 10 and the cloud agent device 20. For example, the edge agent device 10 may be understood as a computing device such as a smart phone, a PC, or a tablet PC. The cloud agent device 20 may be a cloud computing device that operates on a server and may supplement low computing performance of the edge agent device 10.

The personal web node 100 may correspond to a decentralized identifier (hereinafter, DID) of a blockchain network 200. That is, the edge agent device 10 and the cloud agent device 20 having a DID corresponding to the personal web node 100 may access and control the personal web node 100. Operation of the personal app node 100 is controlled by the edge agent device 10 and the cloud agent device 20.

The personal web node 100 may download data from various service providers 300-1, 300-2 and store the data on the personal web node 100. The service providers 300-1, 300-2 may be understood as server devices operated by external services (e.g., SNS, YouTube, OTT, etc.).

In an embodiment, when the personal web node 100 transmits a data download request to the service provider 300-1, in response, the service provider 300-1 may authenticate a user account on the service linked to the personal web node 100 and transmit the data owned by the user account to the personal web node 100. In this case, the service provider 300-1 may issue a data certificate 34 for the data.

The service provider 300-1 may generate personal data 32 by changing the data owned by corresponding user account into a data format supported by the personal web node 100. In addition, the service provider 300-1 may issue the data certificate 34 for the personal data 32. Then, the service provider 300-1 may transmit a data package 30 including the personal data 32 and the data certificate 34 to the personal web node 100.

The data certificate 34 may be understood as a certificate issued in a form of a verifiable credential (VC) according to W3C standardization specifications. The data certificate 34 may include an electronic signature of the service provider 300-1 who is an issuer of the certificate, and may include a DID of the personal web node 100 as an owner of the personal data 32 and a holder of the data certificate 34. Anyone can verify the source, that is, that the personal data 32 was provided by the service provider 300-1, based on the data certificate 34. Anyone can confirm that the personal data 21 is owned by the personal web node 100 corresponding to the DID based on the data certificate 34.

Information about the DID of the personal web node 100 and the DID of the service providers 300-1, 300-2 is stored in a DID registry 210 of the blockchain network 200. Anyone can check the necessary information about the corresponding DID through the blockchain network 200.

The personal web node 100 may have a memory in the edge agent device 10 or a memory in the cloud agent device 20 as a storage for storing the personal data 32. The personal web node 100 that has received the data package 30 may store the original version of the data package 30 in the storage of the personal web node 100.

The personal web node 100 may extract the personal data 32 from the data package 30 and store the personal data 32 in the personal web node 100. The personal web node 100 may integrate and store the personal data 32 in the same format received from different service providers 300-1, 300-2.

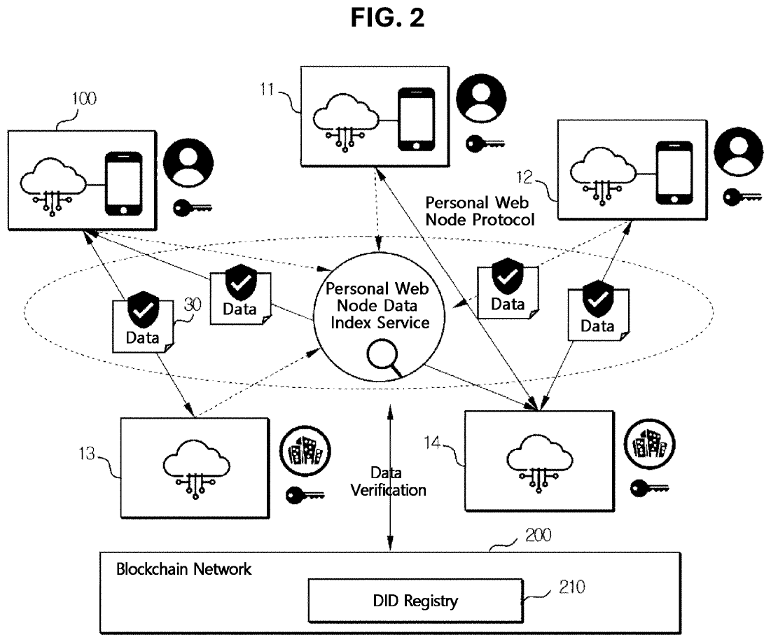

FIG. 2 is a diagram for explaining a personal web node protocol according to an embodiment. Referring to FIG. 2, in addition to the personal web node 100 illustrated in FIG. 1, a plurality of personal web nodes 11, 12, 13, 14 are illustrated. Personal web node protocol refers to behavioral rules of the personal web nodes disclosed in the present disclosure, such as the plurality of personal web nodes 100, 11, 12, 13, 14 storing and exchanging personal data, and performing verification on data.

In one embodiment, anyone, such as an individual or company, who wishes to own or trade data may create a DID that can be registered in the blockchain network 200 and operate a personal web node corresponding to the DID. Each of the plurality of personal web nodes 100, 11, 12, 13, 14 may directly own personal data and trade personal data with each other. Since the plurality of personal web nodes 100, 11, 12, 13, 14 can authenticate meta information (owner, source, etc.) of personal data through the blockchain network 200, they can trust and trade the personal data.

Personal data stored in the plurality of personal web nodes 100, 11, 12, 13, 14 may have a standardized structure. Accordingly, data compatibility between the plurality of personal web nodes 100, 11, 12, 13, 14 is guaranteed.

In various embodiments, the personal web nodes 100, 11, 12 operated by individuals may be controlled by edge agent devices and cloud agent devices, and the personal web nodes 13, 14 operated by companies may be controlled by cloud agent devices.

In various embodiments, personal data may be stored and managed as a personal knowledge graph (hereinafter, PKG) (see personal data 32 of FIG. 1). The plurality of personal web nodes 100, 11, 12, 13, 14 may store and distribute personal data in a standardized structure of PKG. Furthermore, data configuring the PKG may be implemented in compliance with semantic web technology standards (e.g., RDF, JSON-LD, OWL, SPARQL). Accordingly, data storage, management, search, etc. may be performed in a standardized structure, thereby interoperability may be ensured. In addition, when personal data is structured and stored in the PKG format, accurate semantic-based data search can be possible on the personal web node 100.

In various embodiments, the service providers 300-1, 300-2 may provide data formatted in a standardized structure to a personal web node. For example, when the service providers 300-1, 300-2 modify personal data into a PKG structure, an electronic signature of the service providers 300-1, 300-2 may be applied to the modified graph structure. Since this electronic signature is included in the data certificate, anyone can prove data source, ownership, and data integrity for the personal data stored in the personal web node 100 based on the data certificate.

In another embodiment, when the service providers 300-1, 300-2 provide data in a form of a format they each use, the personal web node 100 may modify the data provided into a standardized structure and store the personal data in the modified format.

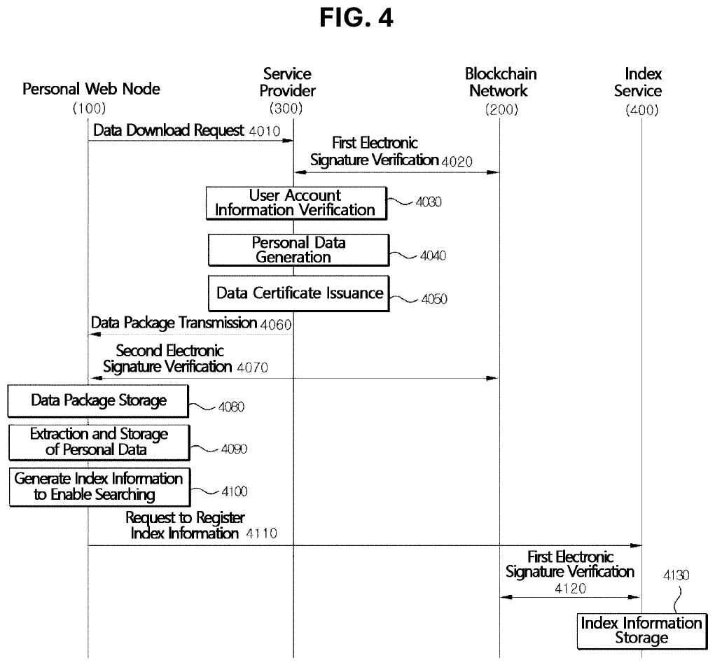

In various embodiments, personal data owned by each of the plurality of personal web nodes 100, 11, 12, 13, 14 may be searched on the personal web node protocol. Data index information that enables searching the personal data owned by the plurality of personal web nodes 100, 11, 12, 13, 14 on the personal web node protocol may be provided (hereinafter, a personal web node data index service (hereinafter, index service) will be described later with reference to FIG. 4).

Individuals, companies, and other entities that need data may search for the data they need and purchase the data by paying a fee to owners of the data (the plurality of personal web nodes (e.g., 100, 11, 12, 13, 14). Since the personal data includes the data certificate 34 issued by the service providers 300-1, 300-2, anyone can verify the ownership, source, and integrity of the personal data through the blockchain network 200.

In various embodiments, the blockchain network 200 may include at least one blockchain network among known public blockchain networks. The blockchain network 200 may include a DID document 210. The DID document 210 may be understood as a storage for DIDs of the plurality of personal web nodes 100, 11, 12, 13, 14 and information related with the DIDs. As identifiers of the plurality of personal web nodes 100, 11, 12, 13, 14 to be described below, the DIDs are described according to a standard specification of World Wide Web Consortium (W3C), a web standardization organization.

In various embodiments, the plurality of personal web nodes 100, 11, 12, 13, 14 can generate a pair of private and public keys based on ECDSA encryption algorithm using secp256k1 curve, EdDSA algorithm using Ed25519 curve, or RSA encryption algorithm. The plurality of personal web nodes 100, 11, 12, 13, 14 can generate electronic signatures based on their respective private keys. In one embodiment, the public key can be used as a DID, or the plurality of personal web nodes 100, 11, 12, 13, 14 can generate a DID separately from the public key.

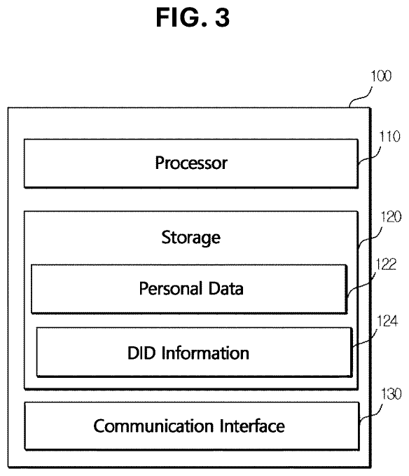

FIG. 3 is a block diagram of a personal web node according to an embodiment. As described above, the personal web node 100 can be controlled by an edge agent device 10 and/or a cloud agent device 20.

The personal web node 100 may include a processor 110, storage 120, and communication interface 130. The processor 110 may include one or more processors included in the edge agent device 10 and cloud agent device 20 for controlling the overall operation of the personal web node 100.

The storage 120 of the personal web node 100 may include memory within the edge agent device 10 or memory within the cloud agent device 20. The storage 120 may include personal data 122 and DID information 124. The personal data 122 can be understood as the personal data downloaded from service providers (e.g., 300-1, 300-2 in FIG. 1) that are integrated and stored. The DID information 124 may include blockchain account (public key/private key) and DID generated by the personal web node 100.

The communication interface 130 can be understood as communication interfaces included in the edge agent device 10 and cloud agent device 20. The personal web node 100 can transmit and receive personal data 122 through the communication interface 130, or verify information (e.g., public key associated with DID) stored in association with DIDs of other personal web nodes through the blockchain network 200 (DID resolution).

FIG. 4 is a signal flow diagram showing a process in which a personal web node 100 downloads personal data (e.g., personal data 122 in FIG. 2) and generates index information for the personal data according to an embodiment.

Hereinafter, it is assumed that the personal web node 100 (e.g., personal web node 100 in FIG. 1) corresponds to a first DID, and the service provider 300 (e.g., service provider 300-1, 300-2 in FIG. 1) corresponds to a second DID. That is, the personal web node 100 can be understood to have generated and stored the first DID and associated private and public keys within the personal web node 100. The service provider 300 can be understood to have generated and stored the second DID and associated private and public keys within the server device. The first DID and second DID can be stored in the DID registry 210 of the blockchain network 200.

Therefore, the first DID can be understood as an identifier of the personal data owner, and the electronic signature of the personal data owner, which is the electronic signature of the personal web node 100, is generated based on the private key associated with the first DID of the personal web node 100 and is verifiable based on the first DID and blockchain network 200. The second DID can be understood as an identifier of the service provider 300, which is the source of the personal data, and the electronic signature of the service provider 300 is generated based on the private key associated with the second DID of the service provider 300 and is verifiable based on the second DID and the blockchain network 200.

The personal web node 100 can transmit a data download request to the service provider 300 (4010). The data download request may include a first electronic signature based on the first DID of the personal web node 100, user account information registered with the service provider 300, and data information requesting download.

The service provider 300 can verify the first electronic signature through the blockchain network 200 (4020). Through this, the service provider 300 can verify that the request of step 4010 was received from the owner of the first DID.

The service provider 300 can verify the user account information (4030). For example, the service provider 300 can verify whether the personal web node 100 is a pre-registered user of the service based on the login process.

The data information can be understood as meta information (e.g., type, period, etc.) about the data desired to be downloaded from the service provider 300.

When the first electronic signature and user account information are verified, the service provider 300 can generate personal data corresponding to the requested data information (4040) and issue a data certificate (e.g., data certificate 34 in FIG. 1) for the generated personal data (4050). The service provider 300 can generate a data package including the personal data and the data certificate, and transmit the data package to the personal web node 100 (4060).

In one embodiment, the data certificate may include the first DID as information about the owner of the personal data and a second electronic signature based on the second DID of the service provider 300 for verifying the source of the personal data.

When the personal web node 100 receives the data package (4060), the personal web node 100 can verify the second electronic signature based on the second DID and blockchain network 200 (4070). The personal web node 100 can obtain the service provider 300's public key based on the second DID from the blockchain network 200 (DID resolution), and verify whether the second electronic signature was generated by the service provider 400's private key based on the public key. Hereinafter, verification of all electronic signatures is performed in this manner.

When the personal web node 100 confirms that the data package was generated by the service provider 300, the personal web node 100 can store the original data package in the storage 120 of the personal web node 100 (4080). In various embodiments, the personal web node 100 can store the personal data in the edge agent device 10 and/or cloud agent device 20 selectively as needed.

The personal web node 100 can extract the personal data from the data package and store the personal data in the storage 120 of the personal web node 100 (4090). If there is pre-stored personal data, the pre-stored personal data and the newly stored personal data can be stored in an integrated manner. The personal web node 100 can store the data certificate for the personal data in the storage 120 of the personal web node 100.

In various embodiments, when personal data is managed in PKG form, the personal web node 100 can extract graph data from the data package and merge it with pre-stored graph data for storage. Personal data can be stored in the form of a single integrated graph.

The personal web node 100 can generate index information to enable searching of the personal data stored in the personal web node 100 (4100). The index information is meta information about the personal data and can consist of data type, attributes, and attribute values. Index information can serve as criteria for data search. An example of index information is shown in the following Table 1.

TABLE 1

| data type | data attribute | data attribute value |
|---|---|---|
| profile information | gender | female |
| media viewing | Youtube video viewing | actual viewing |
| | history | history data |
| hospital treatment | health checkup records | actual health checkup |
| records | | results data |
| transportation | public transportation | actual usage history data |
| | usage history | |

In one embodiment, profile information among data types can be understood as profile information of the actual user of the personal web node 100. For example, data attributes corresponding to profile information may include personal information such as gender, country, age, etc. In various embodiments, the personal web node 100 may selectively request to upload only certain attributes among various profile information attributes, or may request to upload including attribute values for certain attributes. For example, the personal web node 100 can configure the index information to be registered as shown in Table 2.

TABLE 2

| data type | data attribute | data attribute value |
|---|---|---|
| profile information | age | 20s |
| profile information | gender | female |
| media viewing | Youtube video viewing | X (do not transmit) |
| | history | |

The personal web node 100 can transmit an index information registration request to the index service 400 (4110). The index information registration request may include the generated index information and a first electronic signature based on the first DID.

The index service 400 can be understood as a server device that provides index information about data that the plurality of personal web nodes wants to own and distribute on the personal web node protocol. Anyone can implement and provide an index service 400 that complies with the personal web protocol. The index service 400 can provide search functionality for a list of tradeable data to allow data buyers to search and discover needed data.

The index service 400 can verify the first electronic signature included in the index information registration request based on the first DID and blockchain network 200 (4120), and upon completion of verification, can store the index information in the storage of the index service 400 (4130).

In various embodiments, the personal web node 100 can select personal data it wishes to distribute from the personal data it owns, and transmit index information about the selected personal data to the index service 400.

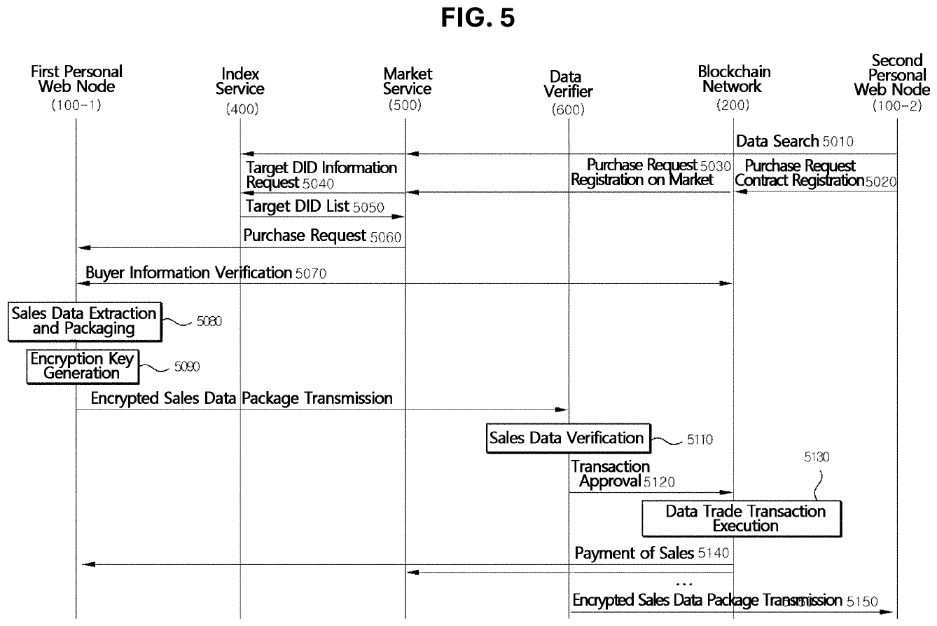

FIG. 5 is a signal flow diagram showing a data transaction process between personal web nodes 100-1, 100-2 according to an embodiment. Referring to FIG. 5, the first personal web node 100-1 on the seller's side wishing to sell data and the second personal web node 100-2 on the buyer's side wishing to purchase data are shown. The first personal web node 100-1 and second personal web node 100-2 can be understood as different personal web nodes having substantially the same configuration as the personal web node 100 disclosed through FIGS. 1 to 4, but with different DIDs.

Referring to FIG. 5, a market service 500 is shown. The market service 500 can be understood as a server device that supports transactions of personal data that that the plurality of personal web nodes wants to own and distribute on the personal web node protocol. Anyone can implement and provide a market service that complies with the personal web protocol. The market service 500 can provide software, such as applications that can provide market functionality, to the first personal web node 100-1 and second personal web node 100-2. The first personal web node 100-1 and second personal web node 100-2 can execute the software and use market functions through the interface of the market service 500.

Through FIG. 4 below, the market service 500 can be implemented to use a pre-established index service 400. The following describes a case where the market service 500 and index service 400 are operated separately.

The second personal web node 100-2 can perform data searches through the market service 500 (5010). The market service 500 can read and retrieve index information provided by the index service 400 and display it through the market service 500's interface to the second personal web node 100-2.

When the second personal web node 100-2 decides on data to purchase, it can submit a transaction to register a purchase request contract to the blockchain network 200 (5020). The data transaction transactions for data trading on the personal web node protocol can be implemented as smart contracts on the blockchain network 200. When a new purchase request contract is registered on the blockchain network 200, the market service 500 can register a purchase request based on the purchase request contract in the market (5030).

According to one embodiment, the purchase request contract may include buyer DID, buyer information, verifier DID, purchase information, purchase price, and purchase quantity. The purchase request contract includes the buyer DID as information about which DID holder registered the purchase request. The buyer information can be understood as identity information of the entity (e.g., individual or company) owning the second personal web node 100-2. The second personal web node 100-2 can configure buyer information by selecting identity information it wishes to disclose. In various embodiments, the buyer information may include a certificate issued in the form of W3C standardized Verifiable Credentials (VC) for the buyer's identity information by a trusted authority. The verifier DID is the DID of the entity that will verify the data being traded and execute the actual data trade transaction based on the purchase request contract, which will be described in detail later.

Purchase information can be understood as search filter information for the personal data desired for purchase. For example, search filter information may include keywords that the buyer wishes to purchase, such as ‘20 s, 30 s/video viewing history’.

Purchase price may mean the price that the buyer will pay for each personal data. Purchase quantity may mean the total number of personal data to be purchased. When submitting the purchase request contract, the second personal web node 100-2 can pre-stake the total purchase amount through the blockchain network 200. For example, if the purchase price is $5 and the purchase quantity is 1,000, the total purchase amount becomes $5000. Each time a data trade transaction is executed according to the purchase request contract, the purchase amount staked by the second personal web node 100-2 can be executed and distributed to the seller's blockchain network 200 account, and if the purchase request is canceled, it is returned to the second personal web node 100-2's blockchain network 200 account.

When a new purchase request is registered, the market service 500 can request DID information (hereinafter, target DID) of personal web nodes that own data matching the purchase request from the index service 400 (5040). The request may include purchase information. The index service 400 can search (filter) pre-registered index information matching the search filter information included in the purchase information, and transmit a target DID list of personal web nodes owning personal data matching the purchase request to the market service 500 (5050). The market service 500 can transmit the purchase request to personal web nodes included in the target DID list (5060).

Hereinafter, it is assumed that the first personal web node 100-1 owns personal data matching the second personal web node 100-2's purchase request. The target DID list in step 5050 may include the DID of the first personal web node 100-1, and the market service 500 can transmit the purchase request through software installed on the first personal web node 100-1 (5060). The purchase request may include purchase information, buyer information, and verifier DID. For example, the buyer information may include a VC-form buyer identity certificate.

In step 5060, when the first personal web node 100-1 receives a purchase request generated according to the purchase request contract registered on the blockchain network 200 through steps 5020 to 5050, the first personal web node 100-1 can verify the buyer identity certificate included in the purchase request through the blockchain network 200. Through the buyer identity certificate, the owner of the first personal web node 100-1 can verify the identity of the entity wishing to purchase data and make a decision on the sale.

If the first personal web node 100-1 approves the purchase request, the first personal web node 100-1 can extract sales data corresponding to the purchase request of step 5060 from the personal data (e.g., personal data 122 in FIG. 1) stored in the storage 120 of the first personal web node 100-1. The first personal web node 100-1 can extract sales data based on search filter information included in the purchase information. The first personal web node 100-1 can generate a sales data package including the extracted sales data and at least one data certificate for the extracted sales data (5080). The first personal web node 100-1 can transmit the generated sales data package to the data verifier 600 (5100).

In operation 5100, the sales data package can be transmitted encrypted so that only the data verifier 600 can decrypt it. For example, the first personal web node 100-1 can generate an encryption key based on the data verifier DID included in the purchase request and the private key associated with the first personal web node 100-1's DID (5090). For example, the first personal web node 100-1 can generate the encryption key based on the verifier public key obtained based on the verifier DID and the private key of the first personal web node 100-2 (Diffie-Hellman key exchange). In operation 5100, the first personal web node 100-1 can encrypt the sales data package based on the encryption key and transmit the encrypted sales data package to the data verifier 600.

The data verifier 600 can be understood as an entity with authority to verify whether the sales data transmitted by the first personal web node 100-1 (seller side) matches the purchase request, and to enable execution of data trade transactions based on the purchase request contract registered by the second personal web node 100-2 (buyer side).

While data trade transactions are executed on the blockchain network 200, an off-chain data verifier 600 is needed because it is difficult to verify on the blockchain network 200 whether the data submitted by the seller actually matches the purchase request. Additionally, since submitting sales data to the blockchain network 200 is practically difficult due to capacity and privacy issues, the data verifier 600 functions as a data submission point.

The data verifier 600 can be designated by the second personal web node 100-2 on the buyer's side. In various embodiments, the verifier DID can be the DID of the second personal web node 100-2 (when the buyer's side designates itself as the data verifier). In various embodiments, the second personal web node 100-2 can designate different verifiers for different purchase contracts. Therefore, when the second personal web node 100-2 registers the plurality of different purchase request contracts, each of these contracts may include different verifier DIDs.

In operation 5100, the first personal web node 100-1 can confirm the address to send the sales data package to the data verifier based on the verifier DID. The first personal web node 100-1 can look up the service endpoint stored in the DID registry 210 of the blockchain network 200 associated with the verifier DID and transmit the sales data package to that service endpoint.

The data verifier 600 can verify the sales data package received from the first personal web node 100-1 (5110). The data verifier 600 can decrypt the encrypted sales data package based on the data verifier 600's private key and verify the sales data. Verification includes checking whether it matches the purchase request and whether the data is unforged. First, the data verifier 600 can verify whether the sales data included in the sales data package matches the purchase request submitted through the purchase request contract. Additionally, the data verifier 600 can verify the at least one data certificate for the sales data through the blockchain network 200 (authenticity of data). When verification of the sales data package is complete, the data verifier 600 can execute the data trade transaction based on the purchase request contract from step 5020 (5120, 5130). That is, if the data verifier 600 verifies that the purchase request from step 5060 matches the sales data included in the sales data package from step 5100 and the at least one data certificate is verified, the data trade transaction according to the purchase request contract can be executed on the blockchain network 200.

When the data trade transaction is executed in step 5130, the sales amount can be paid to the first personal web node 100-1's blockchain network 200 account on the seller's side. At this time, the first personal web node 100-1 can receive a notification about sales proceeds paid according to the execution of the data trade transaction (5140).

In various embodiments at step 5020, the purchase request contract may include purchase amount distribution information. For example, the purchase amount executed according to the data trade transaction can be distributed to the first personal web node 100-1 (seller) as the data owner, the market service 500 as the trading platform, and the service provider 300 as the source of personal data. The buyer's side can specify the distribution rate for the purchase amount when proposing the purchase request. For example, if distribution information specified as 50% for data owner, 30% for platform, 20% for service provider (data source) is included in the purchase request contract, when the data trade transaction is executed, the purchase amount can be executed according to the pre-specified distribution information.

When the data trade transaction executed in operation 5130 is completed, trade information associated with the data trade transaction can be recorded on the blockchain network 200. The trade information may include buyer DID, seller DID, hash value of sales data (or sales data package), and service provider DID that received profit distribution. Since the trade information remains as a log on the blockchain network 200, verification of which entities traded which data can be conducted transparently.

Upon completion of the data trade transaction execution, the data verifier 600 can transmit the encrypted sales data package received from the first personal web node 100-1 to the second personal web node 100-2. The second personal web node 100-2 can decrypt the encrypted sales data package using the data verifier private key corresponding to the previously obtained data verifier DID and acquire the sales data.

In one embodiment, the second personal web node 100-2 can generate data verifier DID and private key/public key before submitting the purchase request contract in step 5020. Since the data verifier 600 is designated by the second personal web node 100-2, the second personal web node 100-2 can register the data verifier DID and service endpoint (e.g., URL) on the DID registry 210 of the blockchain network 200. The first personal web node 100-1 receiving the data verifier DID can obtain the service endpoint based on the data verifier DID (DID resolution) and transmit the sales data package to that service endpoint.

According to various embodiments of the present invention, a service providing data verifier functionality in the personal web node protocol (hereinafter, data verifier service) can be provided in SaaS form. In this case, when the second personal web node 100-2 transmits the generated verifier DID to the data verifier service, the data verifier service can allocate cloud storage space corresponding to the verifier DID and register the address of that storage space by mapping it to the data verifier DID in the DID registry 210.

When the purchase quantity included in the purchase request contract of step 5020 in various embodiments is plural (e.g., when purchasing 100,000 data items), multiple data trade transactions can be executed. In this case, the data verifier 600 can transmit all sales data packages to the second personal web node 100-2 after the multiple data trade transactions are executed and all multiple sales data packages are obtained (step: 5150).

In various embodiments, the market service 500 and index service 400 can be implemented in an integrated manner. For example, when the market service 500 performs both index information management and market service, in operation 5010, when the second personal web node 100-2 performs data search, the market service 500 can generate a target DID list based on pre-stored index information and transmit purchase requests to those target DIDs.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar or related reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). When a component (e.g., a first component) is referred to as being “coupled” or “connected” to another component (e.g., a second component), with or without the terms “functionally” or “communicatively,” it means that the component can be connected to the other component directly (e.g., wired), wirelessly, or through a third component.

Various embodiments as set forth herein may be implemented as software including one or more instructions that are stored in a storage medium that is readable by agent devices (10, 20). For example, a processor (e.g., the processor 110) of the agent devices (10, 20) may invoke at least one of the one or more instructions stored in the storage medium, and execute the invoked instruction. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single subject or multiple subjects. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as those performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A personal web node corresponding to a first identifier, the personal web node comprising:
a storage for storing data; and
at least one processor,
wherein the at least one processor is configured to:
transmit a data download request to a service provider corresponding to a second identifier,
receive a data package including personal data and a data certificate from the service provider, wherein the data certificate includes the first identifier as information about an owner of the personal data, and a second electronic signature based on a second identifier for verifying a source of the personal data,
verify the second electronic signature based on the second identifier and a blockchain network,
extract the personal data from the data package, and
store the personal data and the data certificate for the personal data into the storage.

2. The personal web node of claim 1, wherein the first identifier is stored in the blockchain network as an identifier of the owner of the personal data,
wherein a first electronic signature of the personal web node based on the first identifier is verifiable based on the first identifier and the blockchain network,
wherein the owner of the personal data is proven based on verification of the first electronic signature of the personal web node,
wherein the second identifier is stored in the blockchain network as an identifier of the service provider that is the source of the personal data,
wherein the second electronic signature is verifiable based on the second identifier and the blockchain network, and
wherein the source of the personal data is proven based on verification of the second electronic signature.

3. The personal web node of claim 2, wherein the at least one processor is further configured to:
receive a purchase request generated according to a purchase request contract registered in the blockchain network,
verify a purchaser identity certificate included in the purchase request via the blockchain network,
extract sales data corresponding to the purchase request from the personal data stored in the storage,
generate a sales data package including at least one data certificate for the sales data, and
transmit the sales data package to a data verifier.

4. The personal web node of claim 3, wherein the at least one processor is further configured to:
generate an encryption key based on an identifier of the data verifier included in the purchase request and the first identifier,
encrypt the sales data package based on the encryption key, and
transmit the encrypted sales data package to the data verifier.

5. The personal web node of claim 3, wherein when whether the purchase request matches the sales data and the at least one data certificate for the sales data are verified by the data verifier, a data transaction according to the purchase request contract is executed on the blockchain network, and
wherein the at least one processor is further configured to receive a notification about sales proceeds paid according to the execution of the data transaction.

6. The personal web node of claim 1, wherein the at least one processor is further configured to:
generate index information to enable searching for the personal data, and
transmit the index information and the first electronic signature based on the first identifier to an index service.

7. The personal web node of claim 6, wherein the index information is meta information about the personal data, and is configured with data type, data attribute and data attribute value.
